(19) United States
(12) Patent Application Publication
(10) Pub. No.: US 2017/0214862 A1
(43) Pub. Date: Jul. 27, 2017

(54) PROJECTION VIDEO DISPLAY DEVICE AND CONTROL METHOD THEREOF

(71) Applicant: HITACHI MAXELL, LTD., Ibaraki-shi, Osaka (JP)

(72) Inventors: Takashi MATSUBARA, Tokyo (JP); Sakiko NARIKAWA, Tokyo (JP); Naoki MORI, Tokyo (JP); Minoru HASEGAWA, Tokyo (JP)

(73) Assignee: HITACHI MAXELL, LTD., Ibaraki-shi, Osaka (JP)

(21) Appl. No.: 15/328,250

(22) PCT Filed: Aug. 7, 2014
(86) PCT No.: PCT/JP2014/070884

§ 371 Date: Jan. 23, 2017

(51) Int. Cl. H04N 5/268; G06F 3/01; G06K 9/00; H04N 5/44; H04N 9/31; G06F 3/042

(52) U.S. Cl. CPC H04N 5/268; H04N 9/3194; G06F 3/0425; G06K 9/00375; H04N 5/4403; G06K 9/00355; G06F 3/017

(57) ABSTRACT

A projection video display device 1 includes a signal input unit 120 that receives a plurality of video signals, a projection unit 115 that projects a video to be displayed on a projection plane, an imaging unit 100 that images one or more operators who operate the projection plane, operation detection units 104 to 109 that detect an operation of the operator from the captured image of the imaging unit, and a control unit 110 that controls display of the video to be projected through the projection unit. The control unit selects the video signal to be projected and displayed through the projection unit among the video signals input to the signal input unit based on a detection result of the operation detection unit.

### TECHNICAL FIELD

The present invention relates to a projection video display device and a control method thereof which are capable of projecting and displaying a video on a projection plane.

### BACKGROUND ART

A technique of detecting a user operation and controlling a display position or a display direction of a video such that a state in which a user can comfortably view it is obtained when a video is projected through a projection video display device has been proposed.

Patent Document 1 discloses a configuration in which in an image projection device capable of detecting a user operation on a projection image, a direction in which an operation object (for example, a hand) used for an operation of a user interface by a user moves onto/from the projection image is detected from an image obtained by imaging a region of a projection plane including the projection image, a display position or a display direction of the user interface is decided according to the detected direction, and projection is performed.

Further, Patent Document 2 discloses a configuration in which in order to realize a display state which is more easily viewable even when there are a plurality of users, the number of observers facing a display target and positions of the observers are acquired, a display mode including a direction of an image to be displayed is decided based on the number of observers and the positions of the observers which are acquired, and an image is displayed on the display target in the decided display mode.

### CITATION LIST

### Patent Document

Patent Document 1: JP 2009-64109 A

Patent Document 2: JP 2013-76924 A

### SUMMARY OF THE INVENTION

### Problems to be Solved by the Invention

In the past, when a plurality of video signals are input to a projection video display device, and a video signal is switched and projected, the signal switching is performed by operating a switch or a remote controller installed in the device. However, when the user is located near the projection plane such as a desk surface or a screen, and describes a video being projected while pointing at it, it is inconvenient to switch the signal using the switch or the remote control.

In the techniques disclosed in Patent Documents 1 and 2, the user operation is detected from the captured image, and a display position or a display direction of an already selected video is controlled such that a state in which the user can comfortably views it is obtained, but switching of a plurality of video signals based on the user image is not specifically considered. If the techniques disclosed in Patent Documents 1 and 2 are applied to switching of video signals, an operation for the display state and an operation for signal switching are mixed, and thus erroneous control is likely to be performed. Thus, there is a demand for a technique of identifying both operations.

It is an object of the present invention to provide a technique of detecting a user operation from a captured image and appropriately performing switching of a video signal to be displayed in a projection video display device to which a plurality of video signals are input.

### Solutions to Problems

A projection video display device includes a signal input unit that receives a plurality of video signals, a projection unit that projects a video to be displayed on a projection plane, an imaging unit that images one or more operators who operate the projection plane, an operation detection unit that detects an operation of the operator from a captured image of the imaging unit, and a control unit that controls display of the video to be projected through the projection unit, and the control unit selects the video signal to be projected and displayed through the projection unit among the video signals input to the signal input unit based on a detection result of the operation detection unit.

### Effects of the Invention

According to the present invention, it is possible to implement a projection video display device which is convenient and capable of appropriately performing switching of a video signal to be displayed.

### BRIEF DESCRIPTION OF THE DRAWINGS

FIG. 1 is a diagram illustrating an example of a state that a user operates a display screen of a projection video display device.

FIG. 2 is a diagram illustrating a configuration of a projection video display device according to a first embodiment.

FIG. 3 illustrates a shape of a shadow of a finger of a user which is caused by two lightings.

FIG. 4 is a diagram illustrating influence of a shape of a shadow according to an operation position of a user.

FIG. 5 is a diagram illustrating a shape of a shadow when an operation is performed through a plurality of fingers.

FIG. 6 is a diagram for describing decision of a pointing direction based on a contour line.

FIG. 7 is a diagram illustrating an example of projection according to a rectangular desk.

FIG. 8 is a diagram illustrating an example of projection according to a circular desk.

FIG. 9 is a diagram illustrating an example in which a plurality of videos are displayed according to a plurality of users.

FIG. 10 is a diagram illustrating an example of parallel movement of a display screen by a finger operation.

FIG. 11 is a diagram illustrating an example of rotation of a display screen by a finger operation.

FIG. 12 is a diagram illustrating an example of enlargement/reduction of a display screen by a finger operation.

FIG. 13 is a diagram illustrating an example in which a display screen is rotated by operations of fingers of both hands.

FIG. 14 is a diagram illustrating an example in which a display screen is enlarged or reduced by operations of fingers of both hands.

FIG. 15 is a diagram illustrating a configuration of a projection video display device according to a second embodiment.

FIG. 16 is a diagram illustrating a state in which videos from a plurality of signal output devices are displayed.

FIG. 17 is a diagram illustrating an example of an input switching operation of a display video.

FIG. 18 is a diagram illustrating another example of an input switching operation of a display video.

FIG. 19 is a diagram illustrating another example of an input switching operation of a display video.

FIG. 20 is a diagram illustrating an example of an operation of combining touch operations on a signal output device.

FIG. 21 is a diagram illustrating a configuration of a projection video display device according to a third embodiment.

FIG. 22 is a diagram illustrating an example of a simultaneous display operation of a plurality of videos.

FIG. 23 is a diagram illustrating another example of a simultaneous display operation of a plurality of videos.

FIG. 24 is a diagram illustrating another example of a simultaneous display operation of a plurality of videos.

FIG. 25 is a diagram illustrating an example in which a video screen and a drawing screen are simultaneously displayed.

FIG. 26 is a diagram illustrating an example of a non-contact input switching operation (a fourth embodiment).

FIG. 27 is a diagram illustrating another example of a non-contact input switching operation.

FIG. 28 is a diagram illustrating another example of a non-contact input switching operation.

### MODE FOR CARRYING OUT THE INVENTION

Hereinafter, exemplary embodiments of the present invention will be described with reference to the appended drawings.

### First Embodiment

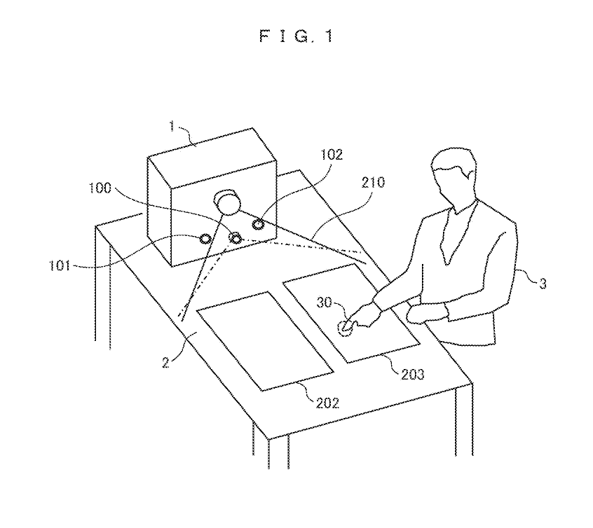

FIG. 1 is a diagram illustrating an example of a state that the user (operator) 3 operates a display screen of a projection video display device 1. Here, an example in which the projection video display device 1 is installed on a desk serving as a projection plane 2, and two display screens 202 and 203 are projected onto the desk is illustrated. The display screens 202 and 203 correspond to on-screen display (OSD) screens, and videos displayed on the display screens 202 and 203 are partial videos in a maximum projection range 210. For example, usage in which a design drawing of a device is displayed in the maximum projection range 210 on the projection plane 2, and explanatory materials of the design drawing are displayed on the display screens 202 and 203 can be implemented. Further, the projection plane 2 is not limited to the desk but may be a screen or a surface of any other structure.

The projection video display device 1 includes a camera (imaging unit) 100 and two lightings 101 and 102 for user operation detection. The two lightings 101 and 102 illuminate the finger 30 of the user 3, and the camera 100 images the finger 30 and an area therearound. The user 3 performs a desired operation (a gesture operation) on a display video by bringing finger 30 serving as an operation object closer to the display screen 203 of the projection plane 2 and touching a certain position. In other words, a region that can be imaged through the camera 100 in the projection plane 2 includes an operation surface on which the user 3 can perform an operation on the projection video display device 1 as well.

Since a shape of a shadow of the finger 30 changes when the finger 30 gets closer to or touches the projection plane 2, the projection video display device 1 analyzes an image of camera 100 and detects proximity, a contact point, and a pointing direction of the finger relative to the projection plane 2. Then, control of the video display mode, the video signal switching, or the like is performed according to various operations performed by the user. Examples of various kinds of operations (gesture operations) by the user 3 and display control will be described later in detail.

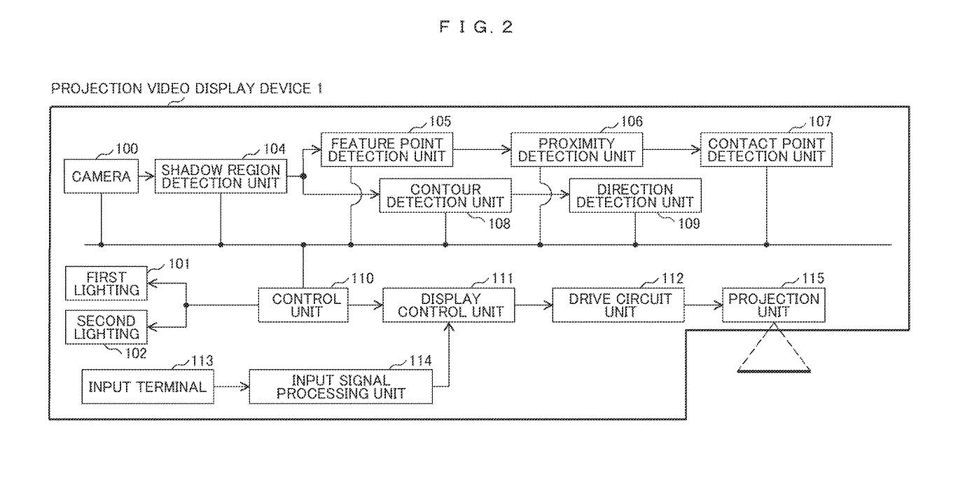

FIG. 2 is a diagram illustrating a configuration of the projection video display device 1 according to the first embodiment. The projection video display device 1 includes the camera 100, the two lightings 101 and 102, a shadow region extraction unit 104, a feature point detection unit 105, a proximity detection unit 106, a contact point detection unit 107, a contour detection unit 108, a direction detection unit 109, a control unit 110, a display control unit 111, a drive circuit unit 112, an input terminal portion 113, an input signal processing unit 114, and a projection unit 115. Among these components, the shadow region extraction unit 104, the feature point detection unit 105, the proximity detection unit 106, the contact point detection unit 107, the contour detection unit 108, and the direction detection unit 109 constitute an operation detection unit that detects the operation of the user 3. A configuration and operation of the respective units will be described below focusing on the operation detection unit.

The camera 100 is configured with an image sensor, a lens, and the like, and captures an image including the finger 30 which is an operation object of the user 3. The two lightings 101 and 102 are configured with a light emitting diode, a circuit board, a lens, and the like, and irradiates the projection plane 2 and the user 3 of the finger 30 with illumination light and projects the shadow of the finger 30 into the image captured by the camera 100. Further, the lightings 101 and 102 may be infrared lightings, and the camera 100 may be configured with an infrared light camera. In this case, it is possible to separate and acquire the infrared light image captured by the camera 100 from a visible light video which is a video of a video signal to be projected from the projection video display device 1 with the operation detection function.

The shadow region extraction unit 104 extracts a shadow region from the image obtained by the camera 100 and generates a shadow image. For example, it is desirable to generate a difference image by subtracting a background image of the projection plane 2 which is imaged in advance from a captured image at the time of operation detection, binarize an luminance of the difference image using a predetermined threshold value Lth, and regard a region of the threshold value or less as the shadow region. In addition, a labeling process of classifying regions of shadows which are not connected as separate shadows is performed on an extracted shadow. Through the labeling process, it is possible to identify a finger corresponding to a plurality of extracted shadows, that is, a pair of shadows corresponding one finger.

The feature point detection unit 105 detects a specific position in the shadow image extracted by the shadow region extraction unit 104 (hereinafter referred to as a “feature point”). For example, a tip position in the shadow image (corresponding to a fingertip position) is detected as the feature point. Various techniques are used for detecting the feature point, but in the case of the tip position, coordinate data of pixels constituting the shadow image can be detected, or a portion identical to a specific shape of the feature point can be detected through image recognition or the like as well. Since one feature point is detected from one shadow, two points are detected for one finger (two shadows).

The proximity detection unit 106 measures a distance d between the two feature points detected by the feature point detection unit 105 and detects a gap s (proximity) between the finger and the operation surface based on the distance d. Thus, it is determined whether or not the finger touches the operation surface.

When the proximity detection unit 106 determines that the finger touches the operation surface, the contact point detection unit 107 detects a contact point of the operation surface by the finger based on the position of the feature point, and calculates coordinates thereof.

The contour detection unit 108 extracts a contour of the shadow region from the shadow image extracted by the shadow region extraction unit 104. For example, the contour is obtained by scanning the inside of the shadow image in a certain direction, deciding a start pixel of contour tracking, and tracking neighboring pixels of the start pixel counterclockwise.

The direction detection unit 109 extracts a substantially linear line segment from the contour line detected by the contour detection unit 108. Then, the direction detection unit 109 detects the pointing direction of the finger on the operation surface based on the direction of the extracted contour line.

The processes of the respective detection units are not limited to the above techniques, but algorithms of other image processing may be used. Further, the respective detection units can be configured with software in addition to hardware using a circuit board.

The control unit 110 controls an operation of the entire apparatus, and generates detection result data such as the proximity of the finger, the contact point coordinates, the pointing direction, and the like with respect to the operation surface which are detected by the respective detection units.

The display control unit 111 generates display control data such as the video signal switching, the video display position, the video display direction, enlargement/reduction, or the like based on the detection result data generated by the control unit 110. Then, the display control unit 111 performs a display control process based on the display control data on the video signal passing through the input terminal 113 and the input signal processing unit 114. Further, the display control unit 111 also generates a drawing screen used for the user to draw characters and diagrams.

The drive circuit unit 112 performs a process for projecting the processed video signal as the display video. The display image is projected from the projection unit 115 onto the projection plane.

The respective units described above have been described as being installed in one projection video display device 1, but the units may be configured as separate units and connected via a transmission line. Further, description of a buffer, a memory, and the like are omitted in FIG. 2, but a buffer, a memory, and the like which are necessary may be appropriate mounted.

A method of detecting finger contact which is the basis of user operation detection (gesture detection) will be described below.

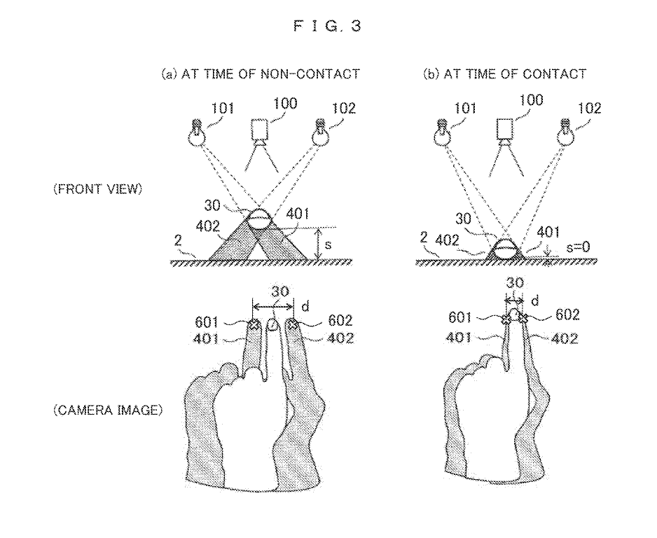

FIG. 3 is a diagram illustrating a shape of a shadow of the finger of the user which is caused by two lightings. (a) illustrates a state in which the finger 30 and the projection plane 2 do not come into contact with each other, and (b) illustrates a state in which the finger 30 and the projection plane 2 come into contact with each other.

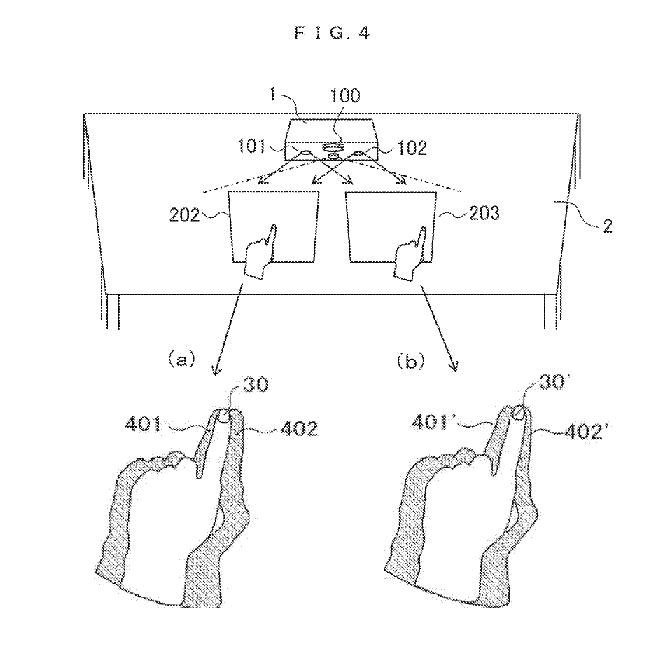

As illustrated in FIG. 4A, in the state in which the finger 30 does not come into contact with the projection plane 2 (the gap s≠0), light from the two lightings 101 and 102 is blocked by the finger 30, and shadows 401 and 402 are formed. In the camera image, the two shadows 401 and 402 are apart from each other and located on both sides of the finger 30.

On the other hand, as illustrated in (b), in the state in which the fingertip of the finger 30 comes into contact with the projection plane 2 (the gap s=0), the two shadows 401 and 402 are close to each other at the position of the fingertip of the finger 30. Further, partial regions of the shadows 401 and 402 are hidden behind the finger 30, the hidden portions are not included in the shadow regions. In the present embodiment, the contact between the finger 30 and the projection plane 2 is determined using a characteristic that the interval between the shadow 401 and the shadow 402 decreases when the finger 30 approaches the projection plane 2.

In order to measure the gap between the shadow 401 and the shadow 402, feature points 601 and 602 are determined in each shadow, and the distance d between the feature points is measured. When each of the tip positions of the shadows 401 and 402 (the fingertip position) is set as the feature point is, it is easy to associate the feature point with the contact position with the projection plane. Even in the state in which the finger does not come into contact with the projection plane, it is possible to classify a level of the proximity (gap s) between the finger and the projection plane based on the distance d between the feature points and perform control according to the proximity of the finger. In other words, it is possible to set a contact operation mode which the finger performs an operation in the contact state and a non-contact operation mode (an aerial operation mode) in which the finger performs in an operation in the non-contact state and switch control contents between the contact operation mode and the non-contact operation mode.

FIG. 4 is a diagram illustrating influence of the shape of the shadow according to the operation position of the user. Here, a camera image when the operation position of the user is deviated from the center of the projection plane 2 to the left side (a) and a camera image when the operation position of the user is deviated from the center of the projection plane 2 to the right side (b) are compared. In (a) and (b), the operation position of the user viewed from the camera 100 changes, but a position relation of the shadows 401 (401′) and 402 (402′) relative to the finger 30 (30′) in the camera images does not change. In other words, there are the shadows 401 (401′) and 402 (402′) on both sides of the finger 30 (30′), regardless of the operation position of the user. It is because it is unambiguously decided by the position relation between the camera 100 and the lightings 101 and 102. Therefore, regardless of a position at which the user operates the projection plane 2, it is possible to detect the two shadows 401 and 402, and it is possible to effectively apply the operation detection method of the present embodiment.

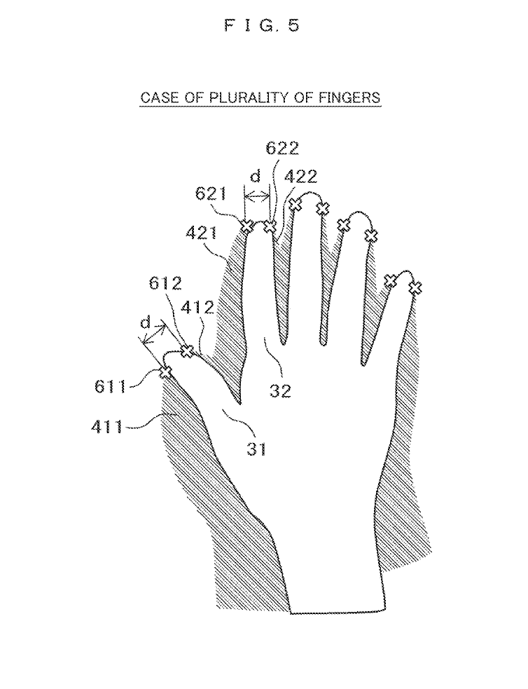

FIG. 5 is a diagram illustrating the shape of the shadow when an operation is performed using a plurality of fingers. When a plurality of fingers 31, 32, . . . are brought into contact with the operation surface in a state in which the hand is opened, shadows 411, 421, . . . on the left side, shadows 412, 422, . . . on the right side are formed. Further, a feature point is set in each shadow. Here, feature points 611 and 612 set in the shadows 411 and 412 and feature points 621 and 622 set in the shadows 421 and 422 are illustrated. By measuring the distance d between the corresponding feature points 611 and 612 or the corresponding feature points 621 and 622, it is possible to obtain the proximity or the contact points of the fingers 31 and 32. Thus, according to the present embodiment, it is possible to detect independently contacts for a plurality of fingers even in the state in which the hand is open, and thus it can be applied to a multi-touch operation.

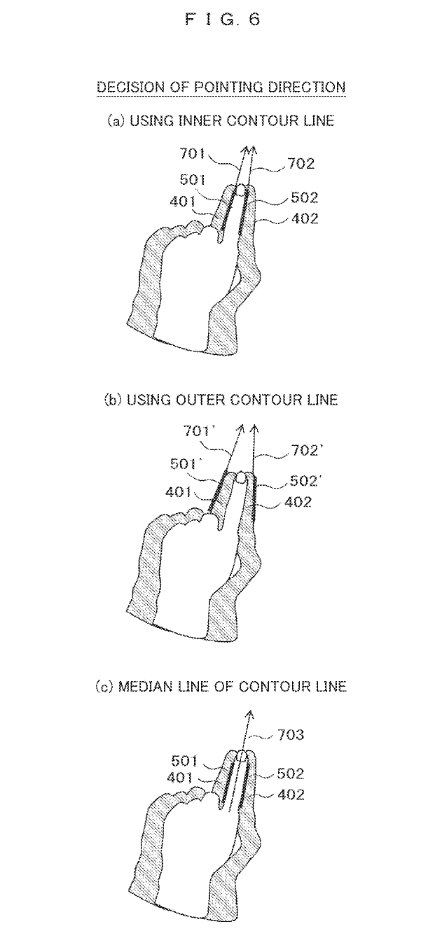

FIG. 6 is a diagram for describing decision of the pointing direction based on the contour line. The shapes of the shadows 401 and 402 when the direction (the pointing direction) of the finger 30 is inclined are illustrated, and the directions of the shadows 401 and 402 change with the change in the pointing direction. In order to detect the pointing direction, first, the contour detection unit 108 detects contour lines 501 and 502 of the shadows 401 and 402. In the detection of the contour line, a curve portion such as the fingertip is removed, and a contour line configured with a substantially linear line segment is detected. Thereafter, the direction detection unit 109 decides the pointing direction using the following method.

In (a), the inner contour lines 501 and 502 of the shadows 401 and 402 are used. Then, one of inclination directions 701 and 702 of the inner contour lines 501 and 502 is decided as the pointing direction.

In (b), outer contour lines 501′ and 502′ of the shadows 401 and 402 are used. Then, one of inclination directions 701′ and 702′ of the outer contour lines 501′ and 502′ is decided as the pointing direction.

In (c), the inner the contour lines 501 and 502 of the shadows 401 and 402 are used. Then, an inclination direction 703 of a median line of the inner contour lines 501 and 502 is decided as the pointing direction. In this case, since the pointing direction is obtained based on an average direction of the two contour lines 501 and 502, the accuracy is high. Further, a median line direction between the outer contour lines 501′ and 502′ may be decided as the pointing direction.

The method of detecting the user operation in the projection video display device 1 has been described above. In the method of detecting the finger contact point and the pointing direction described above, an operation can be performed using the finger or a long thin operation object corresponding thereto. Since it is unnecessary to prepare a dedicated light emission pen or the like, it is much more convenient than a light emission pen method of emitting predetermined light from a pen tip and performing a recognition process.

Next, an example of control of the display screen implemented by the user operation will be described.

First, basic settings such as the number of display screens on the projection plane, the display direction, the display position, and the display size will be described. In an initial state, the basic settings are performed according to a default condition set in the projection video display device 1 or a manual operation performed by the user. While the device is being used, the number of users and the positions of the user may change. In this case, the number of users, the positions of the user, and the shape of the projection plane are detected, and the number of display screens, the display position, the display direction, the display size, and the like are changed to the easily viewable state according to the number of users, the positions of the user, and the shape of the projection plane.

Here, the recognition of the number of users, the positions of the users, the shape of the projection plane, and the like is performed using the captured image of the camera 100 of the projection video display device 1. When the projection video display device is installed on the desk, it is advantages because a distance with a recognition object (the user or the projection plane) is close, and a frequency at which a recognition object is blocked by an obstacle is small. Further, the camera 100 may is configured to image an operation of the user 3 by the finger detection or the like, and another camera that images the position of the user 3 and the shape of projection plane 2 may be installed.

An example of recognizing the shape of the projection plane, the position of the user, and the like and deciding the display orientation of the display screen according to the recognition will be described below.

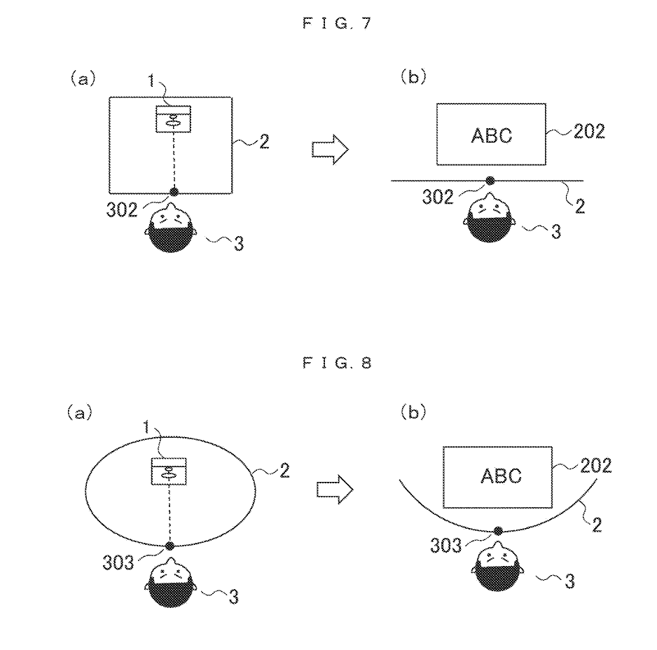

FIG. 7 is a diagram illustrating an example of projection according to a rectangular desk. In (a), the user 3 is recognized as being near the projection plane 2 which is the rectangular desk based on the captured image of the camera of the projection video display device 1. Further, a position of the edge of the desk of a closest portion 302 between the user 3 and the edge of the desk is recognized. (b) illustrates the direction of the display screen 202, and the display direction of the display screen 202 is decided so that the direction of the edge of the position of the closest portion 302 and the bottom of the display video are parallel, and the position of the closest portion 302 is the lower side.

FIG. 8 is a diagram illustrating an example of projection according to a circular desk. In (a), the user 3 is recognized as being near the projection plane 2 which is the circular desk based on the captured image of the camera of the projection video display device 1. Further, a position of the edge of the desk of a closest portion 303 between the user 3 and the edge of the desk is recognized. (b) illustrates the direction of the display screen 202, and the display direction of the display screen 202 is decided so that the direction of the edge of the position of the closest portion 303 and the bottom of the display video are parallel, and the position of the closest portion 303 is the lower side.

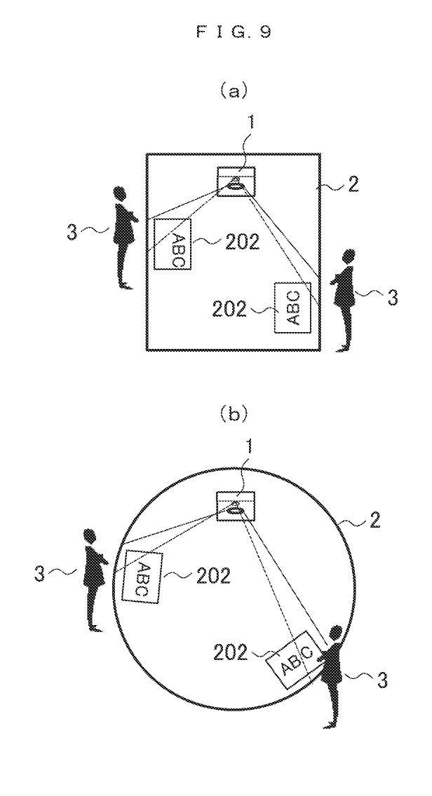

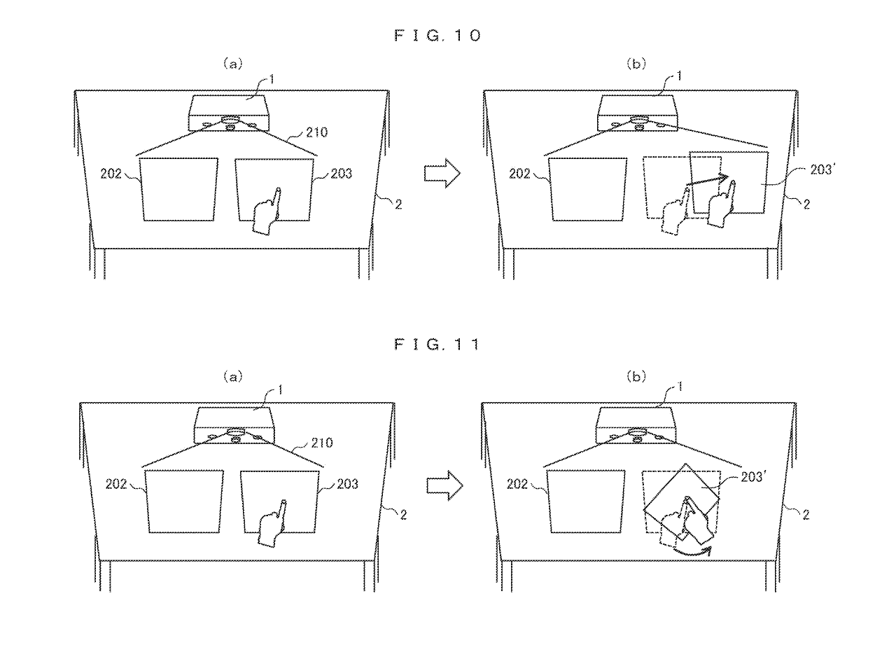

FIG. 9 is a diagram illustrating an example in which a plurality of videos are displayed according to a plurality of users. (a) illustrates an example in which projection onto a projection plane 2 which is the rectangular desk is performed, and (b) illustrates an example in which projection onto a projection plane 2 which is the circular desk is performed. In both cases, a plurality of users and the positions of the users are detected by the camera, and the position and the display direction of the display screen 202 are decided based on the position and the shape of the edge of the desk which is closest to the positions. As described above, it is possible to automatically decide the display direction based on the shape of the edge of the desk which is closest to the user 3.

Next, several examples in which the display state of the screen being displayed is changed by the gesture operation of the user 3 will be described. In this case, an operation is performed by bringing the fingertip of the user into contact with the display screen 202 (the projection plane 2) and moving the position of the fingertip. A range in which the video can be projected onto the projection plane 2 through the projection video display device 1 is indicated by reference numeral 210. For example, the two display screens 202 and 203 are displayed within the display range of the maximum projection range 210.

FIG. 10 is a diagram illustrating an example of parallel movement of the display screen by the finger operation. (a) illustrates a state before the operation, and (b) illustrates a state after the operation. In (a), the finger is brought into contact with the display screen 203 and moved in a desired direction (an upward/downward direction and a left/right direction, and an oblique direction) without changing the direction of the finger. In this case, as illustrated in (b), only the display screen 203 with which the finger is in contact among the display screens 202 and 203 is moved in the same way as the finger moves like a screen 203′. Thus, the desired display screen can be moved to the position desired by the user.

FIG. 11 is a diagram illustrating an example of rotation of the display screen by the finger operation. In (a), the finger which is in contact with the display screen 203 is rotated. In this case, as illustrated in (b), the display direction of the display screen 203 with which the finger is in contact rotates according to the motion of the finger like the screen 203′. Thus, the desired display screen can be moved to the position desired by the user.

In the rotation operation of FIG. 11, the pointing direction among the user operations is detected. Thus, the rotation operation of the display screen can be implemented by rotating the direction of the finger without changing the position of the contact point as illustrated in (b). This is a rotation operation which it is difficult to implement through a touch sensor of a tablet terminal or the like, and this is an operation implemented by the configuration of this embodiment for the first time.

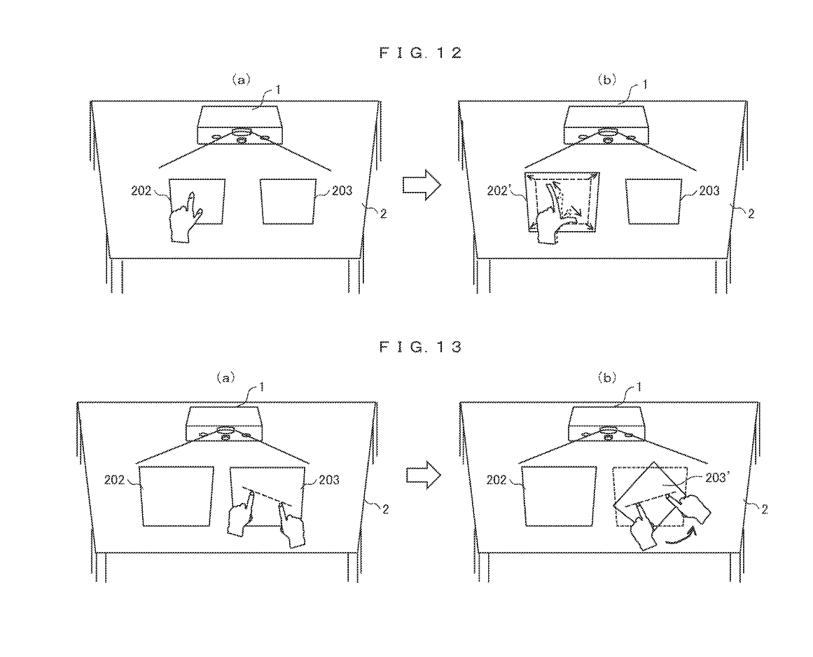

FIG. 12 is a diagram illustrating an example of enlargement and reduction of the display screen by the finger operation. In (a), two fingers which are in contact with the display screen 202 are positioned as if they were placed over rectangle opposite vertices, and in (b), the distance between the two fingers is increased as if a diagonal line connecting the opposite vertices is increased. In this case, the screen is enlarged by a degree by which only the operated display screen 202 is increased, and a screen 202′ is obtained. On the other hand, the screen can be reduced when the two fingers that are in contact with the display screen 202 are moved to get closer to each other. The screen enlargement/reduction operation can be performed in parallel with the movement and the rotation operation of the screen, and thus each display screen can be displayed by effectively using the set maximum projection range 210.

As another operation, it is also possible to divide the display screen and increase the number of screens. The user can generate two screens having the same display content by moving the finger to cut the screen while keeping a contact with the display screen.

Next, an example of a display screen operation using fingers of both hands of the user, that is, a plurality of fingers. According to the screen operation using a plurality of fingers, it is possible to clearly specify the display screen in the rotation process or the size change process and effectively perform the process of the control unit.

FIG. 13 is a diagram illustrating an example in which the display screen is rotated by operation of the fingers of both hands. In a state in which both of two fingers are in contact within the display screen 203 as illustrated in (a), the two fingers are moved so that an inclination of a straight line connecting contact points of the two fingers is changed as illustrated in (b). In this case, the projection video display device 1 changes a display angle according to the change in the inclination, and thus a screen 203′ is displayed. Thus, it is possible to perform the rotation process of the display screen.

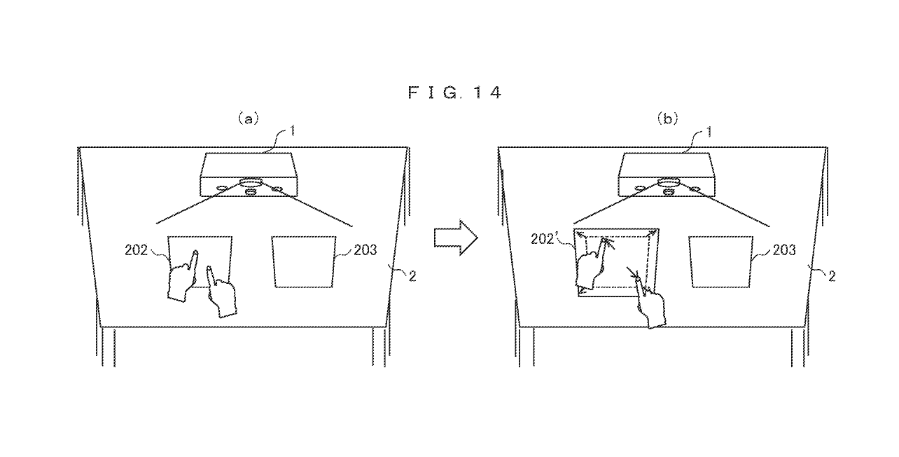

FIG. 14 is a diagram illustrating an example in which the display screen is enlarged or reduce by operation of the fingers of both hands. In a state in which both of two fingers are in contact within the display screen 202 as illustrated in (a), the two fingers are moved so that a length of a straight line connecting contact points of the two fingers is increased as illustrated in (b). In this case, the projection video display device 1 changes a display size according to the change in the length, and thus a screen 202′ is displayed. Thus, it is possible to perform the display screen enlargement process. On the contrary, when the length of the straight line connecting the contact points of two fingers is reduced, the display screen reduction process is performed.

In order to prevent an erroneous operation in the rotation, the enlargement/reduction operation, and the like, an operation may be enabled when both of the two fingers are in contact within the display screen, and an operation may be disabled when one of the fingers is outside the display screen.

In the above operations, first positions at which the two fingers come into contact with the display screen (projection plane) from the air are employed as the contact positions of the two fingers. Thus, for example, when the fingers moves into the display screen from the outside while keeping contact with the projection plane, an operation is not performed. Accordingly, it is possible to simplify the process and improve processing efficiency of the control unit 110. Further, among a plurality of display screens, it is possible to explicitly specify the display screen serving as the processing target.

Further, in the above operations, the contact position of the two fingers are detected, but the control unit 110 determines that two fingers in which a time difference between contacts of the two fingers with the display screen (the projection plane) is within a predetermined time among a plurality of fingers detected by the camera 100 are a combination of fingers used in the above operation. Thus, it is possible to prevent an erroneous operation caused by the time difference between contacts of two fingers.

As described above, according to the first embodiment, it is possible to implement the projection video display device which is capable of efficiently performing the display screen operation through the finger contact detection or the like with a high degree of accuracy.

### Second Embodiment

In a second embodiment, a function of performing input switching of display videos input from a plurality of signal output devices through the gesture operation of the user will be described.

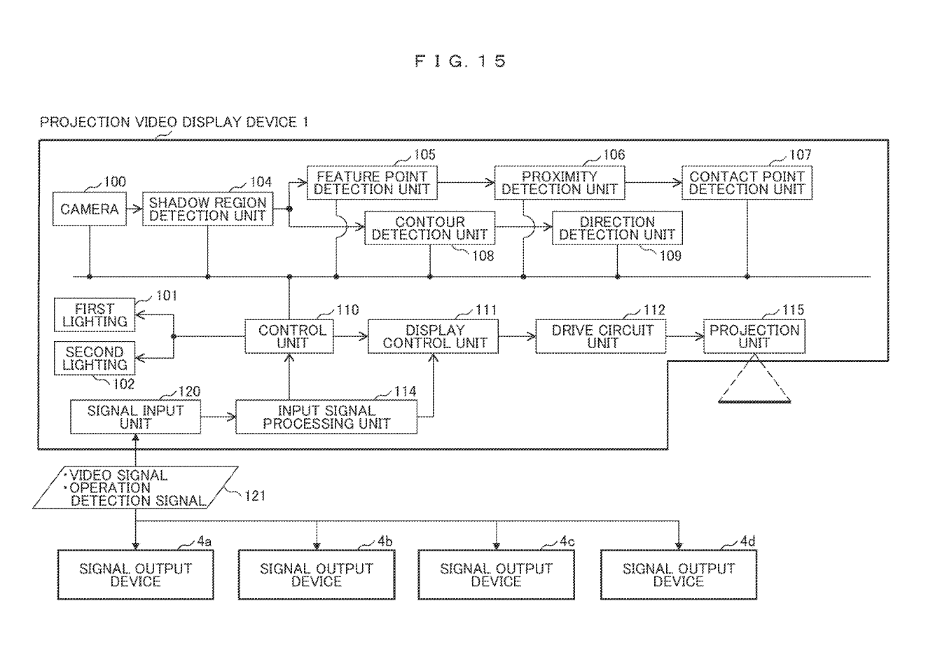

FIG. 15 is a diagram illustrating a configuration of a projection video display device 1 of the second embodiment. In the configuration of the present embodiment, a signal input unit 120 is provided in place of the input terminal 113 of the first embodiment (FIG. 2). The signal input unit 120 is a signal input unit for network video transmission performed via a high-definition multimedia interface (HDMI) terminal, a video graphics array (VGA) terminal, a composite terminal, a local area network (LAN) terminal, or a wireless LAN module, and receives an input signal 121 including a video signal and an operation detection signal from a signal output device outside the projection video display device 1. A signal input method of the signal input unit 120 is not limited to the above-mentioned terminals or the module, and any method can be used as long as the input signal 121 including the video signal and the operation detection signal can be input. Signal output devices 4a, 4b, 4c and 4d are devices such as personal computer (PCs), tablet terminals, smartphones, or cellular phones, and the signal output devices are not limited thereto, and any device that can output the signal 121 including the video signal and the operation detection signal to the projection video display device 1 can be used.

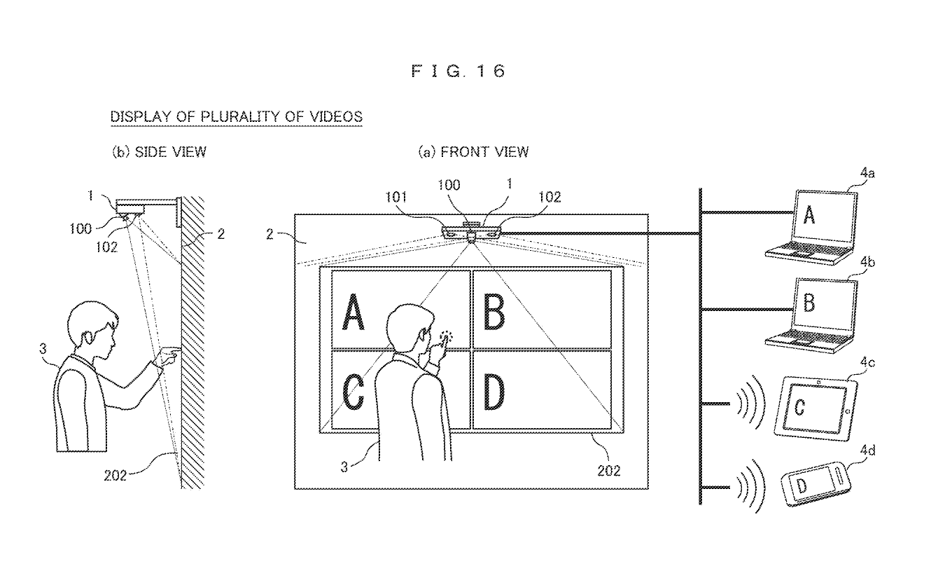

FIG. 16 is a diagram illustrating a state in which videos from a plurality of signal output devices are displayed, and (a) is a front view, and (b) is a side view. A plurality of signal output devices 4a, 4b, 4c, and 4d are connected to the projection video display device 1 through a communication device such as a video transmission cable, a network cable, a wireless connection, or the like. When the user 3 performs the contact operation on the display screen 202 of the projection plane 2, one or more videos output from the signal output devices are simultaneously displayed. In this example, four display videos A to D are simultaneously displayed.

In the present embodiment, when a user operation to be described in the following example is detected, the control unit 110 of the projection video display device 1 determines it to be an input switching operation, and the control unit 110 instructs the display control unit 111 to perform switching to a designated video among a plurality of videos input via the signal input unit 120 and the input signal processing unit 114. Here, at the time of determination of the user operation, when contacts of one or two fingers are detected, the control unit 110 deals them as an operation on a video being displayed, and when contacts of three fingers are detected, the control unit 110 deals them as an operation on input switching of a display video.

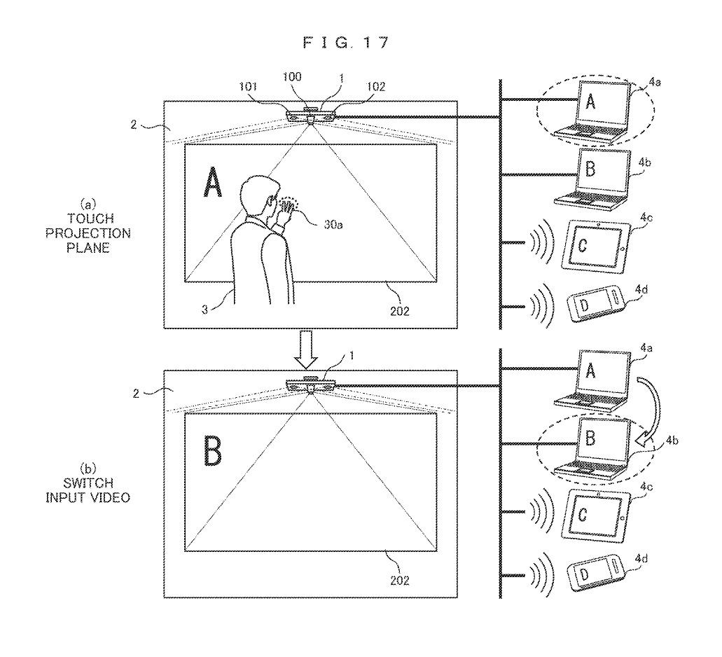

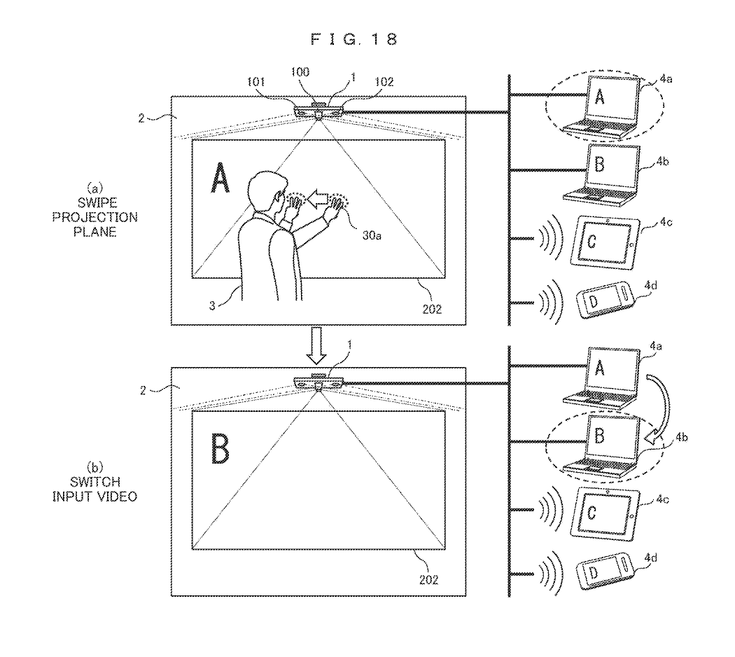

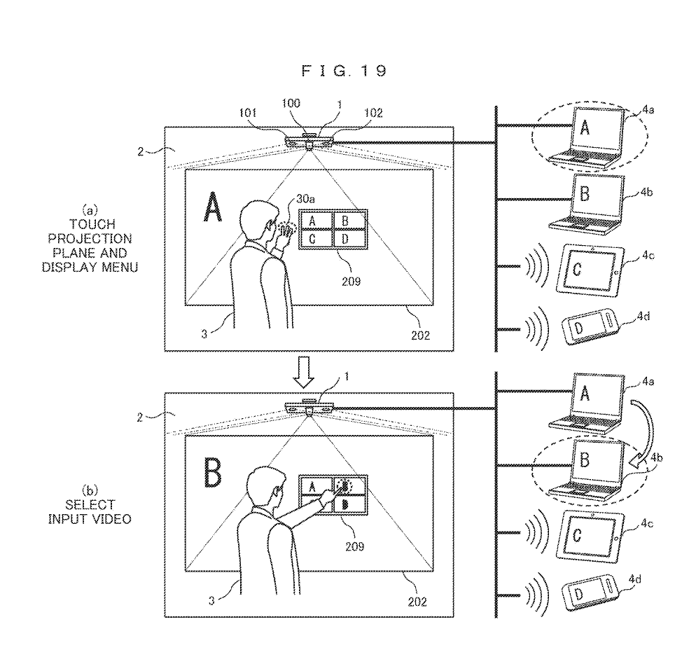

FIG. 17 is a diagram illustrating an example of the input switching operation of the display video. For example, an example in which switching to display of a video B from the signal output device 4b is performed when a video A from the signal output device 4a is displayed. A gesture operation used for switching the display video is performed such that three fingers 30a of the user 3 are brought into contact with the projection plane 2 (the display screen 202) as illustrated in (a). When the gesture of bringing the three fingers 3a into contact with the projection plane is detected, the projection video display device 1 switches its input to the video B output from the signal output device 4b as illustrated in (b). Thereafter, further, each time the three fingers 30a detect the gesture of touching the projection plane, switching of the display video is performed in a predetermined order, for example, switching to a video C output from the device 4c and switching to a video D output from the signal output device 4d are performed in order.

FIG. 18 is a diagram illustrating another example of the input switching operation of the display video. In this example, a swipe operation of bringing the three fingers 30a into contact with the projection plane and moving (sliding) the three fingers 30a in a traverse direction is used as illustrated in (a).

FIG. 19 is a diagram illustrating another example of the input switching operation of the display video. First, when the three fingers 30a come into contact with the projection plane as illustrated in (a), an input switching menu 209 is displayed. Identification numbers A to D of the input videos are displayed on the menu 209. On the other hand, when the user selects a desired video identification number from the input switching menu 209 by the touch operation as illustrated in (b), the selected video B is displayed.

The display position of the input switching menu 209 is a predetermined position at the center or the periphery of the display screen 202. Alternatively, the input switching menu 209 may be displayed near the contact position of the fingers 30a of the gesture shown in (a). Further, when a desired video is selected from the input switching menu 209 as illustrated in (b), the swipe operation of sliding the hand in the lateral direction may be performed instead of the touch operation.

In FIGS. 17 to 19, the contact state of three fingers need not be a state in which the fingers completely come into contact with the projection plane and may include a state in which the fingers are close to the projection plane within a predetermined distance. According to the contact detection methods described in the first embodiment (FIG. 3), it is possible to determine the distance (the gap s) from the projection plane in the non-contact state based on the distance d between the shadows of the finger.

In the present embodiment, the gesture of bringing a specific number of fingers (three fingers) of the user into contact with the projection plane is used as the switching operation of the display video on the projection video display device 1. Thus, it is explicitly distinguished from the operation on the video being displayed which is performed based on the gesture of bringing one or two fingers into contact with it, and an erroneous operation can be prevented. Further, any other gesture (contact of the number of fingers other than three) may be used as long as it can be distinguished from the gesture operation (contact of or two fingers) on the video being displayed.

Further, as another method, in addition to the touch operation on the projection plane by the three fingers, it is possible to switch the input signal more reliably by combining touch operations on the signal output device which is an input source of the video signal.

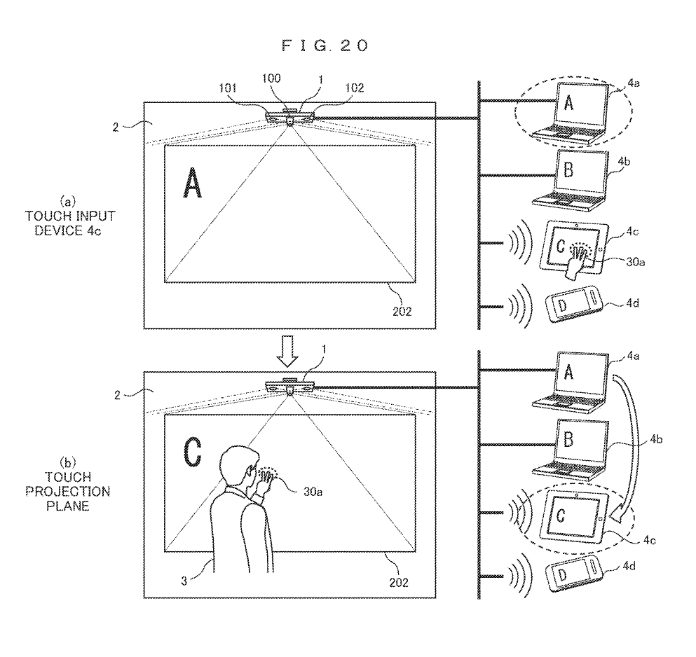

FIG. 20 is a diagram illustrating an example of an operation obtaining by combining touch operations on the signal output device. While the projection video display device 1 is displaying the video A of the signal output device 4a as illustrated in (a), the user 3 performs a gesture of touching the display surface of the signal output device 4c that outputs the video C with the three fingers 30a, and selects the device 4c. Subsequently to this operation, the user 3 performs a gesture of touching the projection plane of the projection video display device 1 with the three fingers 3a as illustrated in (b). As a result, the projection video display device 1 switches the display to the video C of the signal output device 4c selected by the operation of the operation of (a).

The process is performed as follows. When the signal output device 4c detects the gesture illustrated in (a), the signal output device 4c transmits the operation detection signal 121 on the projection video display device 1 via the communication device such as the network cable or the wireless connection. The control unit 110 of the projection video display device 1 receives the operation detection signal 121 from the signal output device 4c via the signal input unit 120 and the input signal processing unit 114. Then, when the gesture illustrated in (b) is detected, the control unit 110 determines the gesture to the input switching operation. Then, an instruction to perform switching to from a plurality of video signals 121 input via the signal input unit 120 and the input signal processing unit 114 to the video C of the signal output device 4c which is a transmission source of the operation detection signal which is already received is given to the display control unit 111.

The gestures illustrated in (a) and (b) are an example, and any other gesture may be used as long as it can be distinguished from other operations. Further, the order of the operations of the gestures illustrated in (a) and (b) may be opposite. In other words, when the gesture illustrated in (b) is detected, the projection video display device 1 is on standby for reception of the operation detection signal from the signal output device. Then, upon receiving the operation detection signal from the signal output device 4c according to the signal illustrated in (a), the projection video display device 1 switches the display to the video C of the signal output device 4c.

The effects of the operations illustrated in FIG. 20 will be described. In the case in which the projection video display device 1 is shared by a plurality of users and used, in the method of switching the video by only the gesture of the user on the projection plane as illustrated in FIGS. 17 to 19, an unexpected erroneous operation may occur due to motions of fingers of a plurality of users near the projection plane. On the other hand, when the method of combining the touch operations on the signal output device as illustrated in FIG. 20, it is possible to reliably perform video switching with no erroneous operation.

Further, the operation illustrated in FIG. 20 is suitable for a motion of the user at the time of presentation. For example, the video C of the signal output device 4c is assumed to be displayed, and the user is assumed to give a presentation to surrounding people who are standing near the display screen 202. At this time, the user performs a motion of touching the screen of the signal output device 4c on his/her hand, moving the screen to the vicinity of the projection plane 2 (the display screen 202), and then touching the display screen 202. In other words, there is an effect in that the user who gives a presentation can smoothly perform the input switching of the projection video display device 1 during the action of moving from his/her seat to the position of the projection plane where the presentation is given.

As described above, according to the input switching function of the second embodiment, when the input video switching from a plurality of signal output devices is performed, it is possible to provide a projection video display device which is convenient for the used.

### Third Embodiment

In a third embodiment, a configuration having a simultaneous display function of simultaneously displaying videos input from a plurality of signal output devices in addition to the function of the second embodiment will be described.

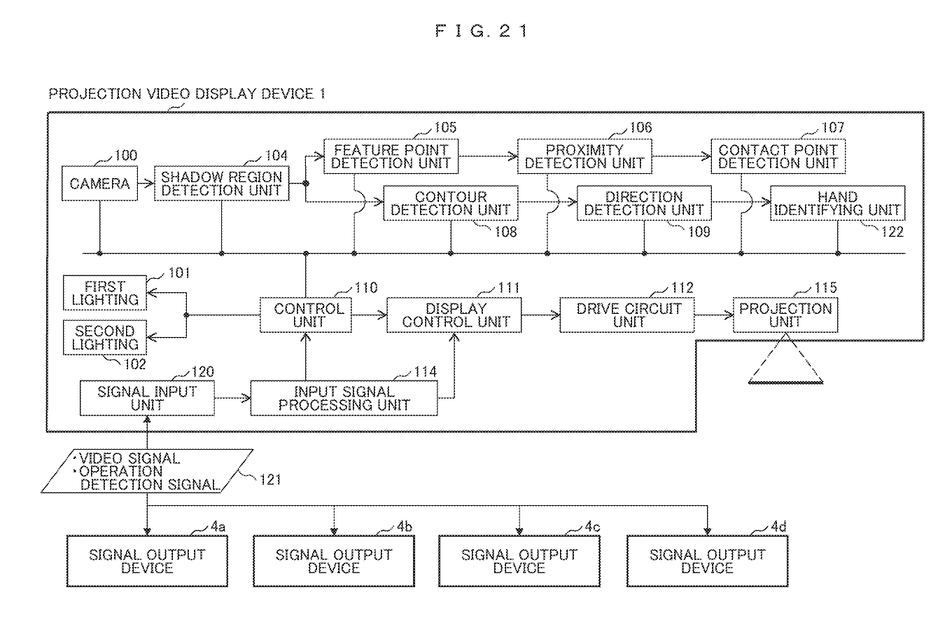

FIG. 21 is a diagram illustrating a configuration of the projection video display device 1 of the third embodiment. A hand identifying unit 122 is added to the configuration of the operation detection unit of the second embodiment (FIG. 15). The hand identifying unit 122 identifies whether a detected hand is a left hand or a right hand. I this technique, a method such as pattern recognition or template matching based on an arrangement of feature points of a plurality of fingers illustrated in FIG. 5 may be used.

In the present embodiment, when a gesture to be described below is detected, the control unit 110 of the projection video display device 1 determines the gesture to be an operation of displaying a plurality of videos simultaneously, and the control unit 110 gives an instruction to simultaneously display two or more display videos designated among a plurality of videos input via the signal input unit 120 and the input signal processing unit 114 to the display control unit 111.

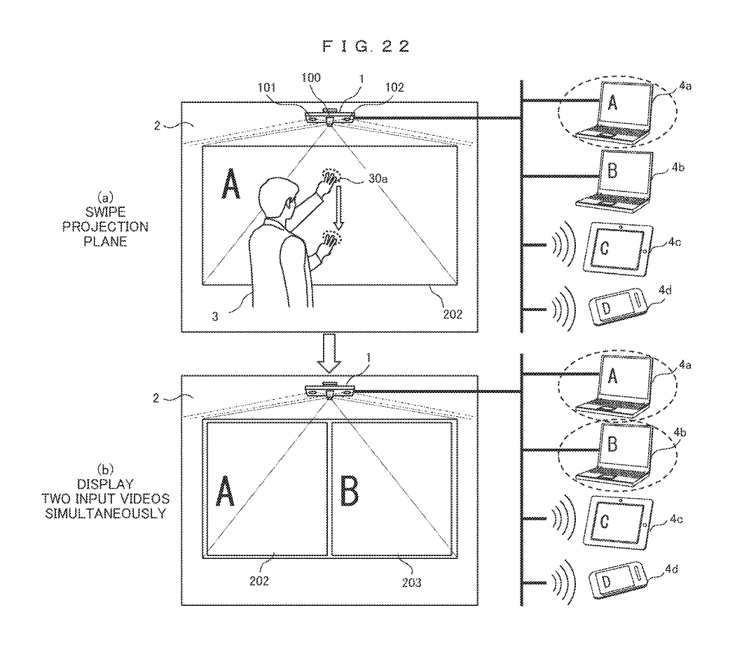

FIG. 22 is a diagram illustrating an example of the simultaneous display operation of simultaneously displaying a plurality of video images. Here, an operation of performing switching to the simultaneous display of the video A of the signal output device 4a and the video B of the signal output device 4b when the projection video display device 1 is displaying the video A of the signal output device 4a is illustrated. In order to switch the display video, the gesture of the swipe operation of moving (sliding) the hand in the vertical direction in the state in which the three fingers 30a are in contact with the projection plane is performed as illustrated in (a). As illustrated in a result (b), the screen is divided into two display screens 202 and 203, and the two videos A and B output from the signal output device 4a and the signal output device 4b are displayed at the same time.

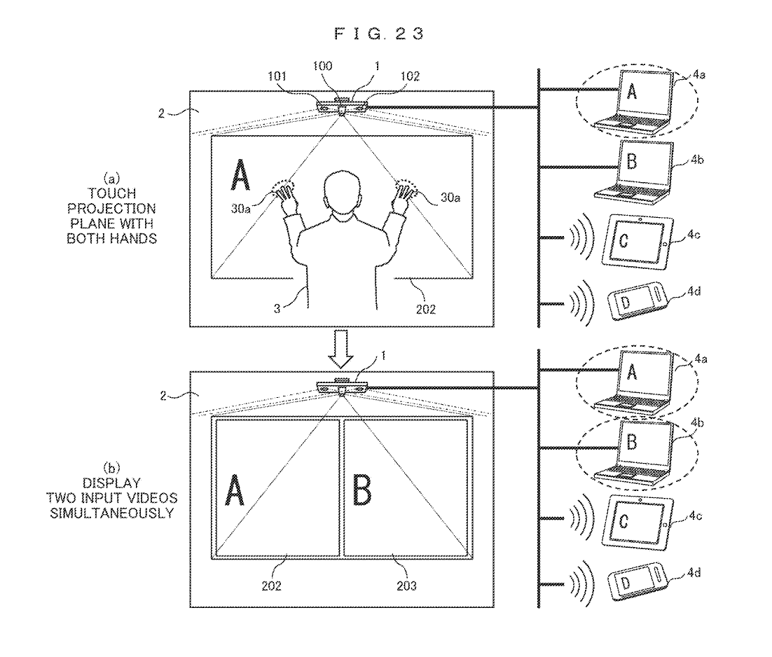

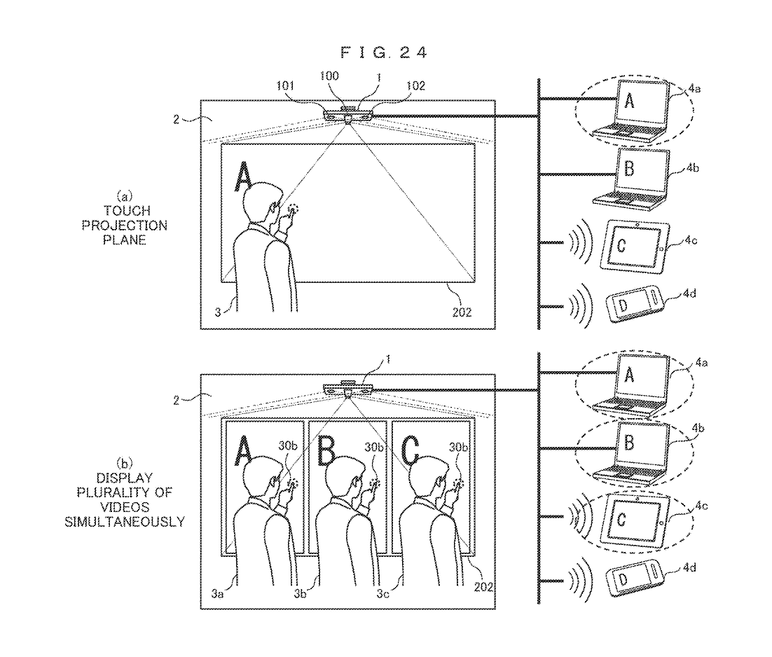

FIG. 23 is a diagram illustrating another example of the simultaneous display operation of simultaneously displaying a plurality of videos. When the user performs a gesture of bringing the three fingers 30a of both hands (a total of six fingers) into contact with the display surface at the same time as illustrated in in (a), the two videos A and B are displayed as illustrated in (b). At that time, the hand identifying unit 122 determines that the fingers of both hands of the user are in contact.

FIG. 24 is a diagram illustrating another example of the simultaneous display operation of simultaneously displaying a plurality of videos. (a) illustrates one video A output from the signal output device 4a in a state before switching, and one the user 3 operates the display screen 202 by touching with one finger. On the other hand, as illustrated in (b), three users 3 a, 3b, and 3c perform an operation of touching the projection plane with one finger 30b of the left hand (or the right hand) at the same time. In other words, when the gesture of touching the three fingers at the same time equivalently, the display screen 202 is divided, and videos A, B, and C output from the three signal output devices 4a, 4b, and 4c are displayed at the same time.

As described above, the gesture operation for simultaneously displaying a plurality of display video is recognized by three fingers touching the projection plane. Thus, it is distinguished from the operation on the video being displayed which is performed contact of one or two fingers, and an erroneous operation can be prevented.

In FIGS. 22 to 24, the contact state of three fingers need not be a state in which the fingers completely come into contact with the projection plane and may include a state in which the fingers are close to the projection plane within a predetermined distance. According to the contact detection methods described in the first embodiment (FIG. 3), it is possible to determine the distance (the gap s) from the projection plane in the non-contact state based on the distance d between the shadows of the finger. The number of divided screens illustrated in FIGS. 22 to 24 is an example, and the number of divided screens may be increased to four or five, and more input videos may be simultaneously displayed.

Further, as a modification of the simultaneous display described above, the drawing screen may be displayed on at least one of the divided display screens.

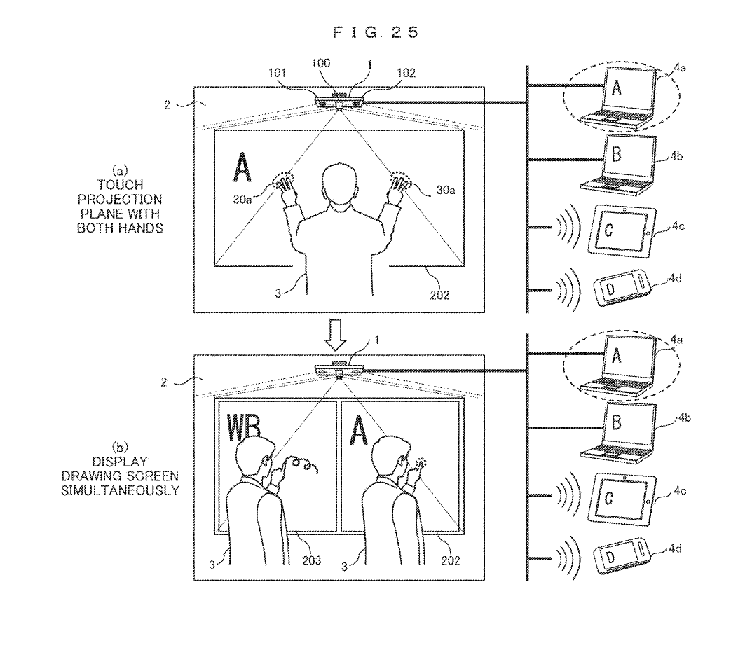

FIG. 25 is a diagram illustrating an example in which the video screen and the drawing screen are simultaneously displayed. In (a), similarly to FIG. 23 (a), when the user 3 brings three fingers 30a of both hands into contact with the projection plane at the same time while the video A output from the signal output device 4a is being displayed, the display screen 202 is divided into two. (b) illustrates a display state of the divided screens, and for example, the video A of the signal output device 4a is displayed on the display screen 202 on the right side, and a drawing screen WB such as a white board is displayed on the display screen 203 on the left side. On the drawing screen WB, the user 3 can draw characters or diagrams through the touch operation (or the pen operation). Through such a display form, video materials or the like output from the signal output device and the user drawing screen for them can be displayed side by side.

In order to perform the above process, the control unit 110 of the projection video display device 1 determines that it is the operation for simultaneously displaying a plurality of videos when the gesture illustrated in FIG. 25(a) is detected, and gives an instruction to simultaneously display two videos, that is, the video A of the signal output device 4a and the video WB for drawing generated by the display control unit 111 to the display control unit 111. Further, in the display screen 202 on the right side of the display screen of (b), when the touch operation is performed with one or two fingers, it is dealt as the screen operation (the touch operation) on the video A being displayed. On the other hand, in the drawing screen 203 on the left side, when the touch operation is performed with one or two fingers, a contact point is detected, the operation of drawing characters or figures on the screen 203 according to the contact point is dealt with, and the locus of drawing is displayed.

Typically, in order to set the display form illustrated in FIG. 25 (b), it is necessary to launch a separate drawing screen and set the touch operation and the drawing operation for each screen, but in this example, since the setting can be simply performed through one operation, it is very convenient.

As described above, according to the simultaneous display function of simultaneously displaying a plurality of videos in the third embodiment, it is possible to provide the projection video display device which is convenient for the user when videos output from a plurality of signal output devices are simultaneously displayed.

### Fourth Embodiment

In a fourth embodiment, a configuration of performing input video switching through a non-contact gesture operation will be described as a modification of the second embodiment.

In the present embodiment, when a non-contact gesture to be described below is detected, the control unit 110 of the projection video display device 1 determines that it is the input switching operation. Further, the control unit 110 gives an instruction to switch the display to a designated video among a plurality of videos input via the signal input unit 120 and the input signal processing unit 114 to the display control unit 111.

For the detection of the gesture operation in the non-contact state, the gap s (proximity) with the projection plane is determined by measuring the gap d between the two shadows as described above in the first embodiment (FIG. 3). Further, when the gesture operation in the non-contact state is used, in order to prevent an erroneous operation with a similar operation in the contact state, it is desirable to set whether each function is enabled or disable through the operation setting menu of the projection video display device 1.

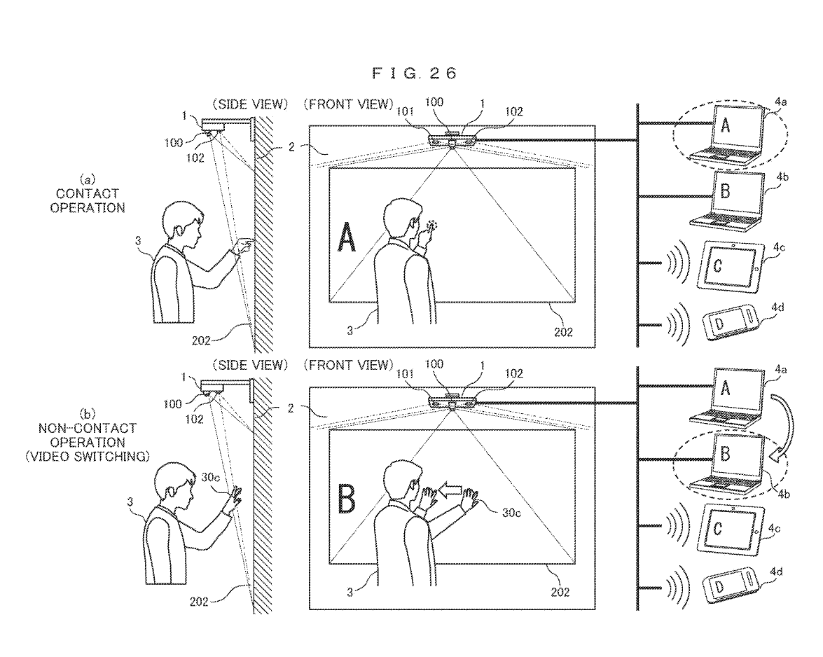

FIG. 26 is a diagram illustrating an example of a non-contact input switching operation. In (a), in a state before switching, the user 3 performs a display operation by touching the display screen 202 on which the video A output from the signal output device 4a is displayed with the finger. On the other hand, as illustrated in (b), the user 3 performs the gesture of the swipe operation of moving (sliding) the finger on the projection plane 2 sideways in the non-contact state in a state 30c in which the hand is opened. As a result, switching to the display of the video B output from the signal output device 4b is performed. Thereafter, each time the non-contact state gesture is performed, switching of the display video is performed in a predetermined order, for example, switching to the video C output from the signal output device 4c and switching to the video D output from the signal output device 4 d are performed in order.

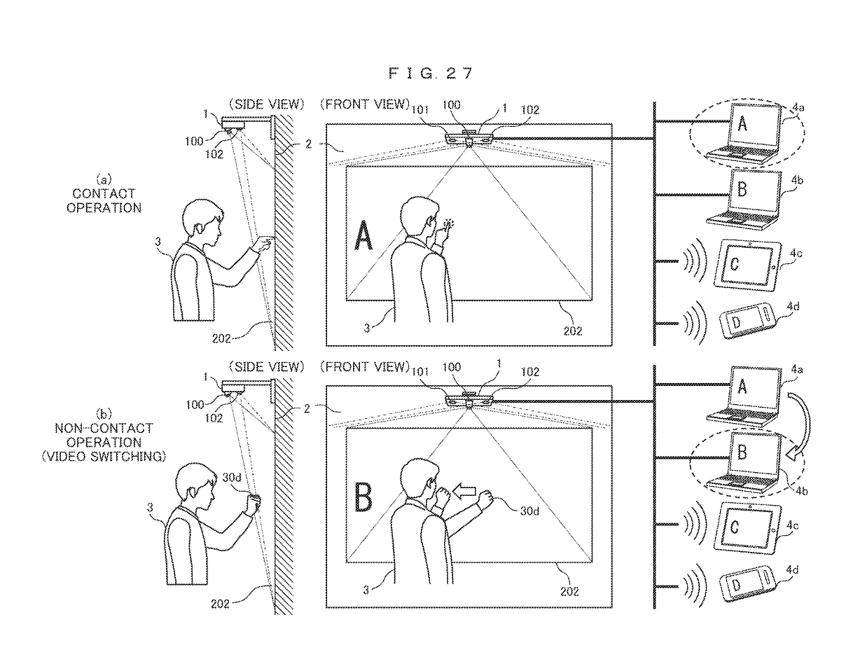

FIG. 27 is a diagram illustrating another example of the non-contact input switching operation. In (a), the video A output from the signal output device 4a is displayed in the state before switching. On the other hand, as illustrated in (b), the user 3 performs the gesture of the swipe operation of sliding the finger on the projection plane 2 sideways in the non-contact state in a state 30c in which the hand is closed. As a result, switching to the display of the video B output from the signal output device 4b is performed. In this case, it is possible to prevent an erroneous operation caused by an unintended motion of the hand when a setting is performed such that input switching can be performed only in the case of a specific hand form (a form 30d in which the hand is clasped).

Further, the gestures illustrated in FIGS. 26(b) and 27(b) are examples, and the form of the hand is not limited thereto as long as the hand is in the non-contact state with the projection plane. Furthermore, even gestures that are the same in the moving direction and the moving distance are distinguished according to whether the hand is in the contact state or the non-contact state with the projection plane, and different processes are performed.

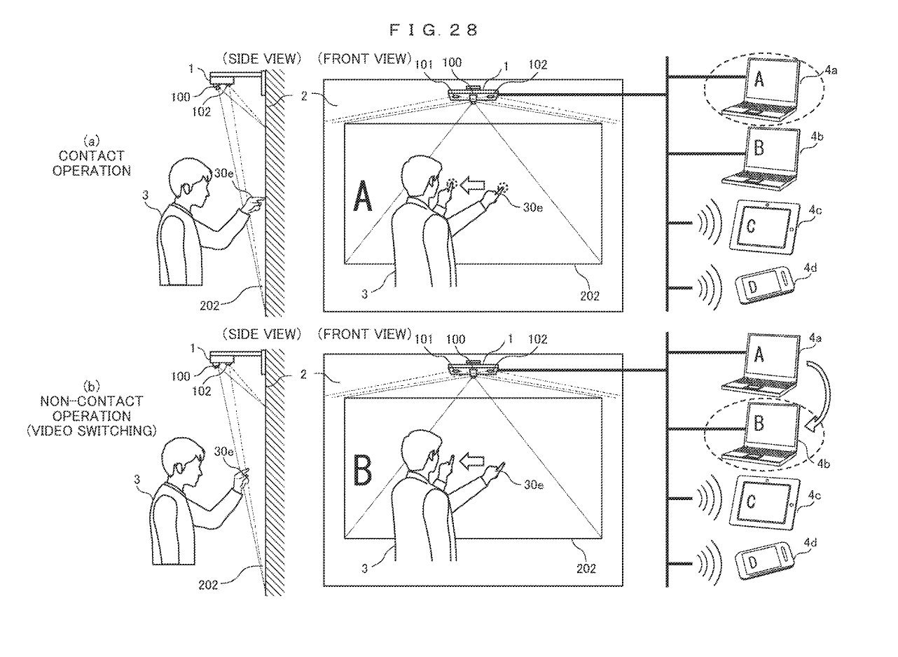

FIG. 28 is a diagram illustrating another example of the non-contact input switching operation. (a) illustrates an example in which the hand form is one finger 30e, and the swipe operation is performed in the contact state. In this case, as a first process, for example, in addition to a page feeding process when the video A output from the signal output device 4a is displayed, a drawing process when the drawing screen is displayed, a drag process when a draggable object is displayed in the display video, and the like allocated. On the other hand, (b) illustrates an example in which the hand form is the same form 30e as in (a), but the swipe operation is performed in the non-contact state. In this case, unlike the first process of (a), in a second process, for example, an input switching process from the video A of the signal output device 4a to the video B of the signal output device 4b is allocated.

As described above, according to the input switching function based on the gesture in the non-contact state according to the fourth embodiment, it is possible to reliably perform the input switching process through, for example, the non-contact swipe operation in which the hand position accuracy is not so high. On the other hand, the gesture operation in the contact state is allocated to a process such as button depression or drawing in which the accuracy of the contact position is required, and thus it is possible to provide the projection video display device which is convenient for the user.

### REFERENCE SIGNS LIST

1 projection video display device
2 projection plane
3 user
4a, 4b, 4c, 4d signal output device
30 finger (hand)
100 camera
101, 102 lighting
104 shadow region extraction unit
105 feature point detection unit
106 proximity detection unit
107 contact point detection unit
108 contour detection unit
109 direction detection unit
110 control unit
111 display control unit
112 drive circuit unit
113 input terminal
114 input signal processing unit
115 projection unit
120 signal input unit
121 input signal
122 hand identifying unit
202, 203 display screen
209 input switching menu
401, 402 shadow
501, 502 contour line
601, 602 feature point

1. A projection video display device that controls a video to be projected and displayed according to an operation of an operator, comprising:
a signal input unit that receives a plurality of video signals;
a projection unit that projects a video to be displayed on a projection plane;
an imaging unit that images one or more operators who operate the projection plane;
an operation detection unit that detects an operation of the operator from a captured image of the imaging unit; and
a control unit that controls display of the video to be projected from the projection unit,
wherein the control unit selects a video signal to be projected and displayed through the projection unit among the video signals input to the signal input unit based on a detection result of the operation detection unit.

2. The projection video display device according to claim 1,
wherein, when the detection result of the operation detection unit indicates that the operator brings a specific number of fingers into contact with the projection plane or the operator brings a specific number of fingers into contact with the projection plane and then moves the fingers, the control unit selects the video signal to be projected and displayed through the projection unit.

3. The projection video display device according to claim 2,
wherein a plurality of signal output devices are connected to the signal input unit, and
the control unit selects a video signal output from the signal output device on which the operator performs a specific operation when the video signal is selected.

4. The projection video display device according to claim 1,
wherein, when the detection result of the operation detection unit indicates that the operator brings a specific number of fingers into contact with the projection plane or the operator brings a specific number of fingers into contact with the projection plane and then moves the fingers, the control unit selects two or more video signals among the plurality of video signals to be input and causes the two or more video signals to be simultaneously projected and displayed through the projection unit.

5. The projection video display device according to claim 4,
wherein the operation detection unit includes a hand identifying unit that identifies whether a hand used for an operation by the operator is a left hand or a right hand, and
when the detection result of the operation detection unit indicates that the operator brings a specific number of fingers into contact with the projection plane using both hands or the operator brings a specific number of fingers into contact with the projection plane and then moves the fingers using one hand, the control unit selects two or more video signals and causes the two or more video signals to be simultaneously projected and displayed through the projection unit.

6. The projection video display device according to claim 4,
wherein, when the control unit selects two or more video signals and causes the two or more videos to be simultaneously projected and displayed, the control unit allocates a function that enables the operator to perform drawing by the operation detection unit to display of at least one video signal.

7. The projection video display device according to claim 1,
wherein, when the detection result of the operation detection unit indicates that the operator moves a finger or a hand in a state in which the finger or the hand is in a non-contact state with the projection plane, the control unit selects the video signal to be projected and displayed through the projection unit.

8. The projection video display device according to claim 7,
wherein, when the detection result of the operation detection unit indicates that the operator moves the hand in a specific form, the control unit selects the video signal to be projected and displayed through the projection unit.

9. A projection video display device, comprising:
a projection unit that projects a video onto a projection plane;
an imaging unit that images an operation object used for operating the projection plane;
an operation detection unit that detects an operation performed by the operation object based on a captured image of the imaging unit; and
a control unit that controls display of the video to be projected through the projection unit based on a detection result of the operation detection unit,
wherein the operation detection unit is capable of identifying whether or not the operation object comes into contact with the projection plane, and
when the detection result of the operation detection unit indicates that the operation object is detected to move while keeping contact with the projection plane, the control unit performs different control on display of the video to be projected for the projection unit from when the detection result of the operation detection unit indicates that the operation object is detected to move in a non-contact state with the projection plane.

10. The projection video display device according to claim 9,
wherein the operation object is a finger of the operator,
when the detection result of the operation detection unit indicates that the finger or a hand of the operator moves while keeping contact with the projection plane, the control unit determines the moving of the finger or the hand to be a valid operation when one or more fingers come into contact with the projection plane, and
when the finger or hand of the operator moves in a non-contact state with the projection plane, the control unit determines the moving of the finger or the hand to be a valid operation when the finger or the hand is a specific form.

11. A control method of a projection video display device that projects a video onto a projection plane, comprising:
a step of imaging an operation object used for operating the projection plane;
a step of detecting an operation performed by the operation object from a captured image; and
a step of controlling display of the video to be projected onto the projection plane based on a detection result of the operation,
wherein in the step of detecting the operation, it is identified whether or not the operation object is in contact with the projection plane, and
when the detection result of the operation indicates that the operation object is detected to move while keeping contact with the projection plane, different control is performed on display of the video to be projected onto the projection plane from when the detection result of the operation indicates that the operation object is detected to move in a non-contact state with the projection plane.

12. The control method of the projection video display device according to claim 11,
wherein the operation object is a finger of the operator,
when the detection result of the operation indicates that the finger or a hand of the operator moves while keeping contact with the projection plane, the moving of the finger or the hand is determined to be a valid operation when one or more fingers come into contact with the projection plane, and
when the finger or hand of the operator moves in a non-contact state with the projection plane, the moving of the finger or the hand is determined to be a valid operation when the finger or the hand is a specific form.
